(19) United States
(12) Patent Application Publication
(10) Pub. No.: US 2025/0253441 A1
(43) Pub. Date: Aug. 7, 2025

(54) THERMAL BARRIER SYSTEMS FOR USE WITHIN TRACTION BATTERY PACKS

(71) Applicant: FORD GLOBAL TECHNOLOGIES, LLC, Dearborn, MI (US)

(72) Inventors: Mohammadreza Eftekhari, Novi, MI (US); Patrick Daniel Maguire, Ann Arbor, MI (US)

(21) Appl. No.: 18/429,640

(22) Filed: Feb. 1, 2024

(51) Int. Cl. H01M 10/658; H01M 10/625

(52) U.S. Cl. CPC H01M 10/658; H01M 10/625; H01M 2220/20

(57) ABSTRACT

Thermal barrier systems are provided for use within traction battery packs. An exemplary thermal barrier system may include one or more expandable gap fillers configured to transition from a compressed state to an uncompressed state when a temperature near the expandable gap filler exceeds a predefined temperature threshold. In the uncompressed state, the expandable gap filler reduces a free air volume of a void space of the traction battery pack, thereby managing or even preventing the transfer of thermal energy to nearby structures.

### TECHNICAL FIELD

This disclosure relates generally to electrified vehicle traction battery packs, and more particularly to thermal barrier systems for managing the transfer of thermal energy within traction battery packs.

### BACKGROUND

A high voltage traction battery pack typically powers the electric machines and other electrical loads of an electrified vehicle. The traction battery pack includes a plurality of battery cells and various other battery internal components that support the electric propulsion of the vehicle.

### SUMMARY

A traction battery pack according to an exemplary aspect of the present disclosure includes, among other things, a void space, and an expandable gap filler arranged within the void space and configured to transition from a compressed state to an uncompressed state when a temperature near the expandable gap filler exceeds a predefined temperature threshold, thereby reducing a free air volume of the void space.

In a further non-limiting embodiment of the foregoing traction battery pack, the void space extends between a first cell tab terminal of a first battery cell and a second cell tab terminal of a second battery cell.

In a further non-limiting embodiment of either of the foregoing traction battery packs, the void space extends between a battery array and an array enclosure top plate.

In a further non-limiting embodiment of any of the foregoing traction battery packs, the void space extends between a battery array and an electronics housing.

In a further non-limiting embodiment of any of the foregoing traction battery packs, the expandable gap filler includes a foam portion and a binding wrapped around the foam portion.

In a further non-limiting embodiment of any of the foregoing traction battery packs, the binding is configured to melt to allow the foam portion to expand when the temperature exceeds the predefined temperature threshold.

In a further non-limiting embodiment of any of the foregoing traction battery packs, the predefined temperature threshold is a melting point of the binding.

In a further non-limiting embodiment of any of the foregoing traction battery packs, the foam portion is comprised of a pliable, high temperature resistant solid foam material.

In a further non-limiting embodiment of any of the foregoing traction battery packs, the pliable, high temperature resistant solid foam material includes silicone foam.

In a further non-limiting embodiment of any of the foregoing traction battery packs, the pliable, high temperature resistant solid foam material includes an intumescent additive.

In a further non-limiting embodiment of any of the foregoing traction battery packs, the binding is comprised of a low melting point material.

In a further non-limiting embodiment of any of the foregoing traction battery packs, the low melting point material includes polyethylene terephthalate (PET).

In a further non-limiting embodiment of any of the foregoing traction battery packs, the low melting point material includes a polyolefin.

In a further non-limiting embodiment of any of the foregoing traction battery packs, in the uncompressed state, the expandable gap filler establishes a thermal barrier within the void space.

A traction battery pack according to another exemplary aspect of the present disclosure includes, among other things, a cell stack including at least a first battery cell and a second battery cell. The first battery cell includes a first cell tab terminal and the second battery cell includes a second cell tab terminal. An expandable gap filler is arranged within a void space that extends between the first cell tab terminal and the second cell tab terminal. The expandable gap filler is configured to transition from a compressed state to an uncompressed state when a temperature within the void space exceeds a melting point of a binding of the expandable gap filler.

In a further non-limiting embodiment of the foregoing traction battery pack, the binding is wrapped around a foam portion of the expandable gap filler.

In a further non-limiting embodiment of either of the foregoing traction battery packs, the binding is made of polyethylene terephthalate (PET).

In a further non-limiting embodiment of any of the forgoing traction battery packs, the foam portion is made of silicone foam.

In a further non-limiting embodiment of any of the forgoing traction battery packs, the expandable gap filler is secured to a surrounding structure that is positioned adjacent to the cell stack.

In a further non-limiting embodiment of any of the forgoing traction battery packs, the surrounding structure is an array enclosure plate or a bus bar module frame.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle that includes a traction battery pack.

FIG. 2 illustrates an expandable gap filler in a compressed state.

FIG. 3 illustrates the expandable gap filler of FIG. 2 in an uncompressed state.

FIG. 4 is a top view of select portions of a battery array of a traction battery pack. The battery array is equipped with a thermal barrier system that includes a plurality of expandable gap fillers.

FIG. 5 illustrates the expandable gap fillers of FIG. 4 in an uncompressed state to establish thermal barriers within the battery array.

FIG. 6 illustrates select portions of another exemplary thermal barrier system for a battery array.

FIG. 7 illustrates a thermal barrier system provided within a traction battery pack.

### DETAILED DESCRIPTION

This disclosure details thermal barrier systems for use within traction battery packs. An exemplary thermal barrier system may include one or more expandable gap fillers configured to transition from a compressed state to an uncompressed state when a temperature near the expandable gap filler exceeds a predefined temperature threshold. In the uncompressed state, the expandable gap filler reduces a free air volume of a void space of the traction battery pack, thereby managing or even preventing the transfer of thermal energy to nearby structures. These and other features are discussed in greater detail in the following paragraphs of this detailed description.

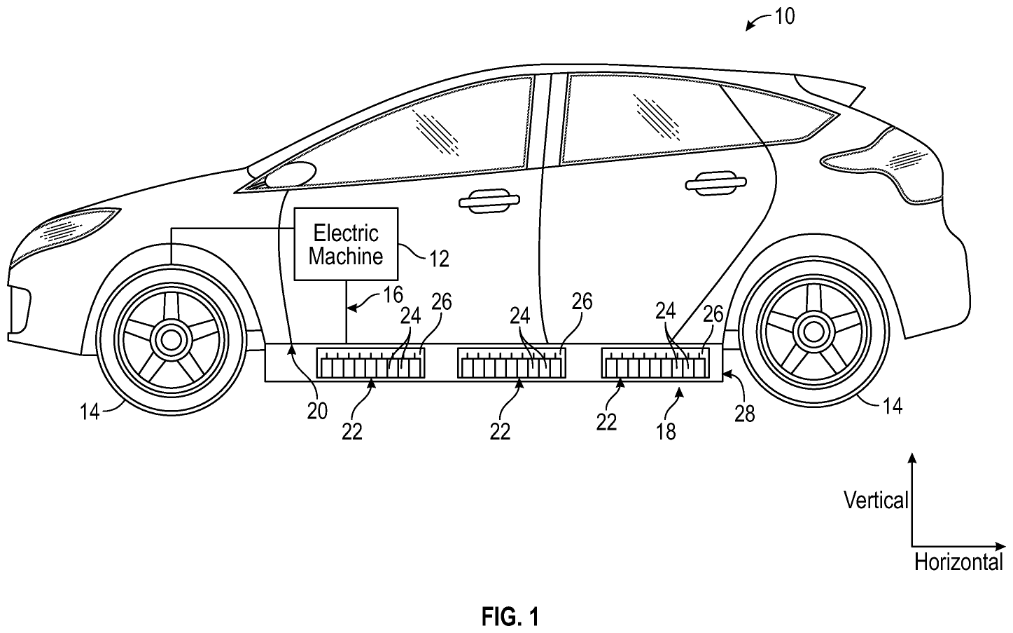

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The one or more battery arrays 22 of the traction battery pack 18 may each include a plurality of battery cells 24 that store energy for powering various electrical loads of the electrified vehicle 10. The traction battery pack 18 could employ any number of battery cells 24 within the scope of this disclosure. Accordingly, this disclosure should not be limited to the highly schematic configuration shown in FIG. 1.

In an embodiment, the battery cells 24 of each battery array 22 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover and an enclosure tray, for example. The enclosure cover may be secured (e.g., bolted, welded, adhered, etc.) to the enclosure tray to provide the interior area 26. The size, shape, and overall configuration of the enclosure assembly 28 is not intended to limit this disclosure.

One or more of the battery cells 24 packaged within the traction battery pack 18 can periodically release vent byproducts, such as during an overcharge condition, an overdischarging condition, a short circuit, etc. The vent byproducts can be released from the battery cells 24 through a vent. Pressure increases within one of the battery cells 24 can cause the vent to rupture, thereby creating a path for the vent byproducts to be released from inside the battery cell 24. This disclosure is primarily directed to thermal barrier systems designed for managing the transfer of thermal energy when one or more of the battery cells 24 release vent byproducts.

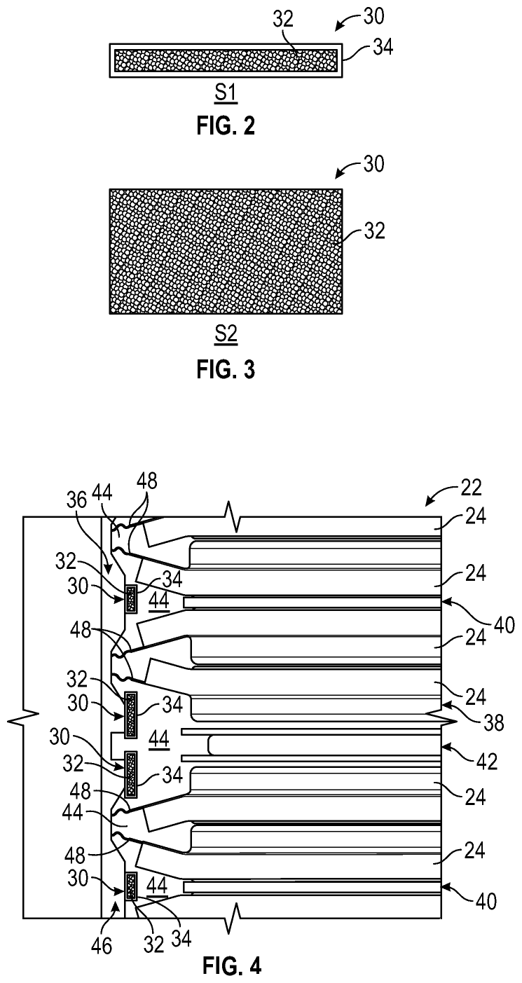

FIGS. 2 and 3 illustrate an exemplary expandable gap filler 30. The expandable gap filler 30 may be strategically positioned at any location where it is desirable to reduce the free air volume of a void space of the traction battery pack 18, thereby significantly minimizing the convective transfer of thermal energy inside the traction battery pack 18 during battery cell venting events.

The expandable gap filler 30 may include an inner foam portion 32 and an outer binding 34. In an embodiment, the expandable gap filler 30 includes a block-like shape. However, the specific size and shape of the expandable gap filler 30 are not intended to limit this disclosure.

The foam portion 32 may be compressed and wrapped or otherwise bound by the binding 34. The foam portion 32 may be completely or partially wrapped by the binding 34. In an embodiment, the binding 34 is vacuum-formed about the foam portion 32. However, other manufacturing techniques may be utilized within the scope of this disclosure to apply the binding 34 about the foam portion 32.

The foam portion 32 may be made of a pliable, high temperature resistant solid foam material. Exemplary foam materials suitable for the foam portion 32 include but are not limited to silicone foam, polyurethane foam, polyethylene foam, ethylene propylene diene monomer (EPDM) foam, polyvinyl chloride (PVC) foam, or acrylic based polymeric materials. However, other foam materials or combinations of materials could alternatively or additionally be utilized within the scope of this disclosure.

In an embodiment, the high temperature resistant solid foam material of the foam portion 32 may include intumescent additives, such as expandable graphene or mono ammonium phosphate, for example, that can undergo an endothermic reaction when exposed to heat. However, other materials or combinations of materials may be utilized as part of the foam portion 32 within the scope of this disclosure.

The binding 34 may be made of a relatively low melting point material compared to the foam portion 32. Exemplary materials suitable for the binding 34 include but are not limited to polyethylene terephthalate (PET) or polyolefins such as polyethylene or polypropylene. However, other low melting point materials or combinations of materials could alternatively or additionally be utilized within the scope of this disclosure.

The expandable gap filler 30 may be configured to transition from a compressed state S1 (see FIG. 2) to an uncompressed state S2 (see FIG. 3) when exposed to heat. For example, when a temperature near the expandable gap filler 30 exceeds a predefined temperature threshold, such as the melting point of the binding 34, for example, the binding 34 may rapidly melt and allow the foam portion 32 to expand and thus increase its effective volume. In the uncompressed state S2, the expandable gap filler 30 can establish a thermal barrier within the environment within which it is packaged. The thermal barrier can better manage or even prevent the transfer of thermal energy to nearby structures.

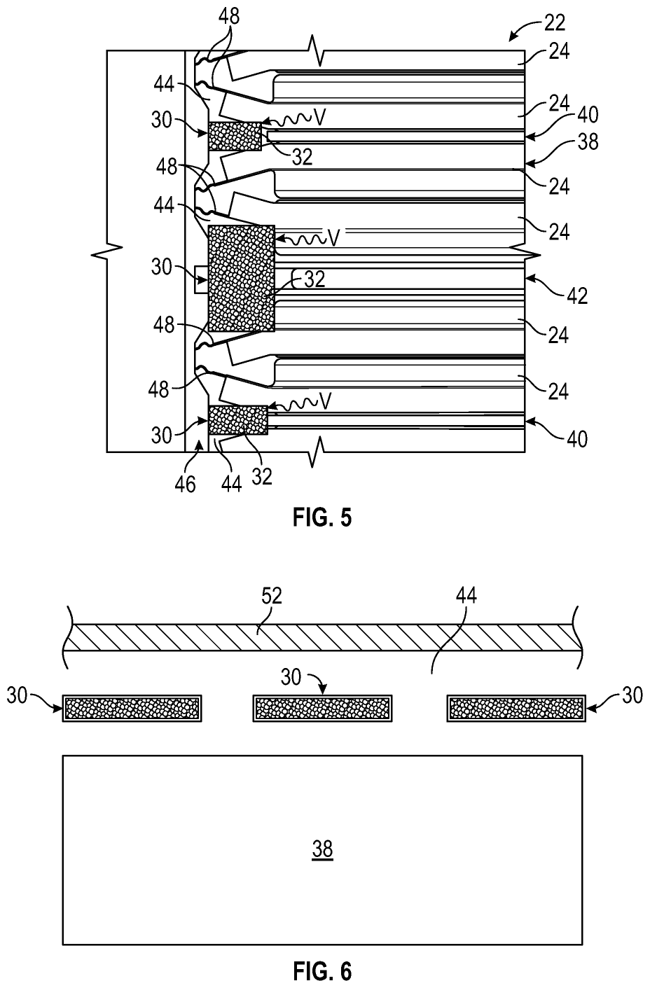

FIGS. 4 and 5 illustrate an exemplary implantation in which a plurality of expandable gap fillers 30 establish a thermal barrier system 36 within a battery array 22. The total number of expandable gap fillers 30 provided as part of the thermal barrier system 36 can vary and is thus not intended to limit this disclosure.

The battery array 22 may include a plurality of battery cells 24. The total number of battery cells 24 provided within the battery array 22 could vary and is also not intended to limit this disclosure. The battery cells 24 may be grouped together in a cell stack 38. The cell stack 38 may optionally additionally include one or more cell-to-cell compressible barriers 40 and/or one or more cell-to-cell thermal barriers 42 that can be arranged between adjacent battery cells 24 of the cell stack 38. Although not specifically shown for the sake of simplicity and clarity, an array enclosure (e.g., top plate, bottom plate, end plates, side plates, etc.) of the battery array 22 may be arranged to substantially surround the cell stack 38.

Each expandable gap filler 30 of the thermal barrier system 36 may be arranged within a void space 44 of the battery array 22. The void spaces 44 may extend between the cell stack 38 and a surrounding structure 46 of the battery array 22. The surrounding structure 46 could be a portion of an array enclosure, a portion of a bus bar module frame, or any combination of these and/or other structures of the battery array 22.

In an embodiment, the expandable gap fillers 30 are positioned between cell tab terminals 48 of adjacent battery cells 24 of the cell stack 38 (see, e.g., FIG. 4). The expandable gap fillers 30 could be secured (e.g., adhered) directly to the surrounding structure 46 or could alternatively be unattached to any nearby structure and therefore are free-floating between the adjacent cell tab terminals 48.

In another embodiment, the expandable gap fillers 30 are positioned in one or more void spaces 44 that extend between the cell stack 38 and an array enclosure top plate 52 (see, e.g., FIG. 6). However, other arrangements are contemplated within the scope of this disclosure, and it should be understood that the expandable gap fillers 30 could be arranged within any void space of the battery array 22 where it is desirable to limit the transfer of thermal energy.

Each expandable gap filler 30 of the thermal barrier system 36 may be configured to transition from the compressed state shown in FIG. 4 to the uncompressed state shown in FIG. 5. In the compressed state, the expandable gap fillers 30 do not substantially fill the void spaces 44 and therefore provide sufficient clearance space for accommodating normal battery function, such as to accommodate battery cell expansion forces, for example. In the uncompressed state, the expandable gap fillers 30 substantially fill the void spaces 44 and therefore provide a near zero clearance for constraining the movement of gas, debris, and energy associated with vent byproducts V released when one or more of the battery cells 24 vent.

The expandable gap fillers 30 may each be configured to transition from the compressed state to the uncompressed state when a temperature near the expandable gap filler 30 exceeds the melting point (e.g., about 120 degrees Celsius) of the material of the respective binding 34 of the expandable gap filler 30. The temperature near the expandable gap fillers 30 may exceed the melting point of the binding 34, for example, when the one or more battery cells 24 of the cell stack 38 vent and release vent byproducts V. When this occurs, the binding 34 of the expandable gap filler 30 may rapidly melt and allow the foam portion 32 to expand, thereby effectively decreasing the free air volume of the void space 44 (as schematically shown in FIG. 5). The uncompressed expandable gap filler 30 can therefore establish a thermal barrier within the void space 44 for mitigating the cell-to-cell and/or array-to-array convective transfer of thermal energy.

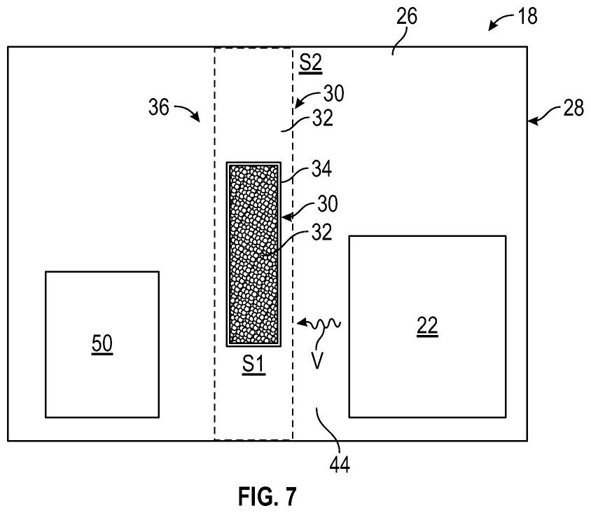

FIG. 7 illustrates another exemplary implementation in which one or more expandable gap fillers 30 may establish a thermal barrier system 36 within a traction battery pack 18. The expandable gap filler 30 of the thermal barrier system 36 may be arranged within a void space 44 of the interior area 26 within the enclosure assembly 28 of the traction battery pack 18. The void space 44 may extend between a battery array 22 and an electronics housing 50 of the traction battery pack 18, for example. The electronics housing 50 may house battery internal components such as a bussed electrical center, battery electric control module, etc.

The expandable gap filler 30 of the thermal barrier system 36 may be configured to transition from a compressed state S1 to an uncompressed state S2 (shown in dashed lines). In the compressed state S1, the expandable gap filler 30 does not substantially fill the void space 44 and therefore provides sufficient clearance space for accommodating normal battery function. In the uncompressed state S2, the expandable gap filler 30 more substantially fills the void space 44 and therefore establishes a thermal barrier that can prevent the transfer of thermal energy from the battery array 22 to the electronics housing 50.

The expandable gap filler 30 may transition from the compressed state S1 to the uncompressed state S2 when a temperature near the expandable gap filler 30 exceeds a melting point (e.g., about 120 degrees Celsius) of the material of the binding 34 of the expandable gap filler 30. The temperature near the expandable gap filler 30 may exceed the melting point of the binding 34, for example, when the one or more battery cells of the battery array 22 vent and release vent byproducts V. When this occurs, the binding 34 of the expandable gap filler 30 may rapidly melt and allow the foam portion 32 to expand, thereby effectively decreasing the free air volume of the void space 44. The uncompressed expandable gap filler 30 can therefore establish the thermal barrier between the battery array 22 and the electronics housing 50.

The exemplary thermal suppression systems of this disclosure are designed to incorporate expandable gap fillers for mitigating the transfer of thermal energy within a battery array and/or a traction battery pack. The systems may provide numerous advantages over known solutions, including but not limited to presenting an electrically non-conductive configuration that rapidly slows or even prevents the cell-to-cell and/or the array-to-array transfer of thermal energy.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a void space; and
an expandable gap filler arranged within the void space and configured to transition from a compressed state to an uncompressed state when a temperature near the expandable gap filler exceeds a predefined temperature threshold, thereby reducing a free air volume of the void space.

2. The traction battery pack as recited in claim 1, wherein the void space extends between a first cell tab terminal of a first battery cell and a second cell tab terminal of a second battery cell.

3. The traction battery pack as recited in claim 1, wherein the void space extends between a battery array and an array enclosure top plate.

4. The traction battery pack as recited in claim 1, wherein the void space extends between a battery array and an electronics housing.

5. The traction battery pack as recited in claim 1, wherein the expandable gap filler includes a foam portion and a binding wrapped around the foam portion.

6. The traction battery pack as recited in claim 5, wherein the binding is configured to melt to allow the foam portion to expand when the temperature exceeds the predefined temperature threshold.

7. The traction battery pack as recited in claim 6, wherein the predefined temperature threshold is a melting point of the binding.

8. The traction battery pack as recited in claim 5, wherein the foam portion is comprised of a pliable, high temperature resistant solid foam material.

9. The traction battery pack as recited in claim 8, wherein the pliable, high temperature resistant solid foam material includes silicone foam.

10. The traction battery pack as recited in claim 8, wherein the pliable, high temperature resistant solid foam material includes an intumescent additive.

11. The traction battery pack as recited in claim 5, wherein the binding is comprised of a low melting point material.

12. The traction battery pack as recited in claim 11, wherein the low melting point material includes polyethylene terephthalate (PET).

13. The traction battery pack as recited in claim 11, wherein the low melting point material includes a polyolefin.

14. The traction battery pack as recited in claim 1, wherein, in the uncompressed state, the expandable gap filler establishes a thermal barrier within the void space.

15. A traction battery pack, comprising:
a cell stack including at least a first battery cell and a second battery cell;
the first battery cell including a first cell tab terminal;
the second battery cell including a second cell tab terminal; and
an expandable gap filler arranged within a void space that extends between the first cell tab terminal and the second cell tab terminal, wherein the expandable gap filler is configured to transition from a compressed state to an uncompressed state when a temperature within the void space exceeds a melting point of a binding of the expandable gap filler.

16. The traction battery pack as recited in claim 15, wherein the binding is wrapped around a foam portion of the expandable gap filler.

17. The traction battery pack as recited in claim 16, wherein the binding is comprised of polyethylene terephthalate (PET).

18. The traction battery pack as recited in claim 16, wherein the foam portion is comprised of silicone foam.

19. The traction battery pack as recited in claim 15, wherein the expandable gap filler is secured to a surrounding structure that is positioned adjacent to the cell stack.

20. The traction battery pack as recited in claim 19, wherein the surrounding structure is an array enclosure plate or a bus bar module frame.
